(19) United States
(12) Patent Application Publication
(10) Pub. No.: US 2006/0226386 A1
(43) Pub. Date: Oct. 12, 2006

(54) Coupler with expanding fittings

(76) Inventors: Kenneth C. Kramer JR., Branchburg, NJ (US); Basily B. Basily, Middlesex, NJ (US)

Correspondence Address: LITMAN LAW OFFICES, LTD, PO BOX 15035, CRYSTAL CITY STATION, ARLINGTON, VA, 22215, US

(21) Appl. No.: 11/250,757

(22) Filed: Oct. 17, 2005

Related U.S. Application Data
(63) Continuation-in-part of application No. 11/102,826, filed on Apr. 11, 2005.

(51) Int. Cl. F16K 51/00

(52) U.S. Cl. 251/148

(57) ABSTRACT

The coupler with expanding fittings can be configured with an inner sleeve having an annular wall with an outwardly extending lip about an end of the sleeve. The wall of the inner sleeve can have a passage defined therein extending from adjacent the valve body and having a discharge opening adjacent the lip, or can have external threading on the outwardly extending lip. The coupler has an outer sleeve with an attached pipe flange at a first end and an inwardly extending lip at an opposing second end. The inner sleeve lip is slidably or threadingly disposed within the outer sleeve, the outer sleeve lip encircling the inner sleeve. The outer sleeve travels along the outward surface of the lip of the inner sleeve, the range of travel of the order sleeve being limited by the inwardly extending lip on the outer sleeve.

This application is a continuation-in-part of U.S. patent application Ser. No. 11/102,826, filed Apr. 11, 2005, which is incorporated herein by reference.

### BACKGROUND OF THE INVENTION

1. Field of the Invention

The present invention relates generally relates to pipe fittings, and more particularly to a coupler with expanding fittings that has hydraulically or pneumatically operated or threaded flanges that extend in order to interconnect pipes and provide flow of any type of material, such as fluid, gas, solid, or any combination thereof, in any type of piping system, e.g., shipping applications, marine applications, building applications, vehicle applications, aviation applications, etc.

2. Description of the Related Art

Virtually every commercial, industrial, residential site, as well as every marine, aviation, train, vehicular application utilizes piping for the conveyance of materials such as liquids, gases, solids, and/or combinations thereof. The most common piping application is for water. Whether it is the water pipes in a private home, high-pressure steam lines in a power plant, saltwater cooling lines aboard a ship, or the water mains in a treatment plant, water pipes are very common.

Some piping installations, such as those used in industrial or marine settings, can be very complicated. Liquids and gases are conveyed at a large variety of temperatures and pressures through an array of different kinds of pipes made from such diverse materials as cast and wrought iron, steel, stainless steel, copper, brass, lead, non-ferrous and ferrous alloys, and plastic materials. Adding to this complexity is the fact that many piping systems must be installed in cramped or confined quarters, leaving little room to perform maintenance or repair on the piping system.

The work of installing and maintaining pipe systems is called pipe fitting. Valves are often used in pipe systems. A valve is a device having an orifice fitted with a suitable seating surface and a means for closing the orifice. A piping system can have as many valves as are needed to assure complete and adequate control of flow. Complete sectionalizing of a piping system is important from the standpoint of both maintenance and control. Some valves, such as globe valves, are used to throttle the flow through a pipe. Other types of valves, such as gate valves, are normally kept either fully open or fully closed. In larger piping installations, i.e., those utilizing piping of two inches or greater, the inlet and outlet of a valve are flanged. The flanges on the valve are bolted to the flanges on a pipe, usually with a gasket between the flange on the pipe and the flange on the valve.

Pipe fitters and other personnel who perform maintenance and repair on piping systems often encounter serious difficulties, particularly when they have to remove and replace pipe sections and/or valves. Most piping systems are designed with some amount of flexibility through the use of compression fittings, expansion joints, slip joints and pipe bends. However, coupler with expanding fittings that would eliminate many of the difficulties in pipe systems has not been put forward. There have been numerous improvements relating to piping systems.

Europe Patent Application Publication No. EP 326 645 A2, published Aug. 9, 1989, describes a high pressure pipe connection of a hydraulic fitting featuring a sealed but detachable end piece capable of resisting hydraulic pressure up to 420 bars. World Intellectual Property Organization Patent Application Publication No. WO 90/14536 A1, published Nov. 29, 1990, describes a valve for connection to a pressurized water main having a closure mechanism that is biased towards a position in which it seals with a seat in the inlet port.

Japan Patent Application Publication No. JP 2-256998 A, published Oct. 17, 1990, discloses a piping repair method for replacing old pipe connections with new pipe connections by fitting an expansion joint pipe having a stopper flange into an opening at the cut part of an old pipe. Japan Patent Application Publication No. JP 3-89091 A, published Apr. 15, 1991, shows a process for the repair and replacement of water main gate valves in underwater installations wherein the connection pipe is removed from a single pipe and valves may be repaired or replaced without performing underwater work.

Japan Patent Application Publication No. 5-196175 A, published Aug. 6, 1993, describes a joint pipe with metal piece for fitting hydraulic piping that enables one kind of a joint pipe to be adapted to a plurality of types of hydraulic piping. Japan Patent Application Publication No. 6-346498 A, published Dec. 20, 1994, discloses a member for connecting a gate valve that abuts the flange surface of the internal valve of a vacuum type sewage system.

Japan Patent Application Publication No. JP 7-110072 A, published Apr. 25, 1995, shows a gate valve wherein the generation of corrosion and rust can be prevented in the valve body by applying an inner layer of corrosion proof resin. Germany Patent Application Publication No. DE 43 38 663 C1, published Jun. 8, 1995, describes a process for exchanging drill fittings on gas pipes or household water mains while maintaining the seals between the pipelines and fittings.

Japan Patent Application Publication No. JP 7-190276 A, published Jul. 28, 1995, describes a connection structure for a gate valve accomplished by connecting a reception port processing piece to an inserting side pressing piece by a connecting member. Europe Patent Application Publication No. EP 1 029 987 A1, published Aug. 23, 2000, shows a service connection at a public water main supply wherein the valve closure element is a spring-loaded ball pressed against a sealing seat in the valve housing.

Japan Patent Application Publication No. JP 2001-021078 A, published Jan. 1, 2001, shows a hydraulic fitting having an inexpensive general purpose hydraulic pressure sensor integrated in to the fitting. Japan Patent Application Publication No. JP 2004-125090 A, published Apr. 22, 2004, describes an installation and construction method for a butterfly valve wherein the butterfly valve is in constant water.

None of the above inventions and patents, taken either singly or in combination, is seen to describe the instant invention as claimed. Thus, a coupler with expanding fittings solving the aforementioned problems is desired.

### SUMMARY OF THE INVENTION

The present invention is a coupler with expanding fittings. The coupler with expanding fittings is designed to eliminate the cost and labor of interconnecting pipes and/or valves in any type of piping system. The coupler with expanding fittings is very cost efficient, since it enables a pipe to be installed without cutting and welding on a piping installation to fit a pipe having a fixed distance between flanges in a pipe run. The expanding fittings may be used in combination with any type of pipe known in the art.

In a first embodiment, the coupler with expanding fittings is configured with an inner sleeve having an annular wall with an outwardly extending lip about an end of the pipe. The wall of the inner sleeve has a passage defined therein extending from adjacent the valve body and having a discharge opening adjacent the lip. The coupler has an outer sleeve with an attached pipe flange at a first end and an inwardly extending lip at an opposing second end. The inner sleeve lip is slidably disposed within the outer sleeve, the inner sleeve lip encircling the inner sleeve. The outer sleeve travels along the outward surface of the lip of the inner sleeve, the range of travel of the outer sleeve being limited by the inwardly extending lip on the outer sleeve.

In a second embodiment, the coupler with expanding fittings is configured with an inner sleeve having an annular wall with an outwardly extending lip about an end of the sleeve. The outwardly extending lip has external threading formed therein. The coupler has an outer sleeve with an attached pipe flange at a first end, an inwardly extending lip at an opposing second end, and an internally threaded wall disposed between the first end and the second end. The internally threaded wall is in threaded engagement with the inner sleeve. Rotation of the outer sleeve results in changing the distance between ends of the coupler, the range of travel of the outer sleeve being limited by the inwardly extending lip on the outer sleeve.

These and other features of the present invention will become readily apparent upon further review of the following specification and drawings.

### BRIEF DESCRIPTION OF THE DRAWINGS

FIG. 1A is a perspective view of a first embodiment of a coupler with expanding fittings according to the present invention.

FIG. 1B is a sectional view of the coupler with expanding fittings shown in FIG. 1A.

FIG. 2A is a perspective view of the coupler with expanding fittings according to the present invention, wherein the coupler is interconnected to a pipe with a fixed flange.

FIG. 2B is a sectional view of the coupler with expanding fittings shown in FIG. 2A.

FIG. 3A is a perspective view of the coupler with expanding fittings according to the present invention, wherein the coupler is interconnected to a globe valve that is interconnected to a coupler with a fixed flange.

FIG. 3B is a sectional view of the coupler with expanding fittings shown in FIG. 3A.

FIG. 4A is a perspective view of an embodiment of the coupler with expanding fittings according to the present invention, wherein the coupler is connected to a globe valve that is interconnected to another coupler with expanding fittings according to the present invention.

FIG. 4B is a sectional view of the coupler with expanding fittings shown in FIG. 4A.

FIG. 5 shows a prospective view an alternative embodiment of a coupler with expanding fittings according to the present invention.

FIG. 6A shows a sectional view of the coupler of FIG. 5 in a retracted position.

FIG. 6B shows a sectional view of the coupler of FIG. 5 in an extended position.

FIG. 7A is a perspective view of the coupler of FIG. 5, wherein the coupler is interconnected to a pipe with a fixed flange.

FIG. 7B is a sectional view of the coupler with expanding fittings shown in FIG. 7A.

FIG. 8A is a perspective view of the coupler with expanding fittings of FIG. 5, wherein the coupler is interconnected to a globe valve that is interconnected to a coupler with a fixed flange.

FIG. 8B is a sectional view of the coupler with expanding fittings shown in FIG. 8A.

FIG. 9A use a perspective view showing another alternative embodiment a coupler with expanding fittings according to the present invention.

FIG. 9B is a section view of the coupler of FIG. 9A.

FIG. 10A is a perspective view of a globe valve equipped with the coupler of FIG. 5 at one end and the coupler of FIG. 9A at the other end.

FIG. 10B is a sectional view of the embodiments of the coupler of FIG. 10A.

Similar reference characters denote corresponding features consistently throughout the attached drawings.

### DETAILED DESCRIPTION OF THE PREFERRED EMBODIMENTS

The present invention is a coupler with expanding fittings. The coupler with expanding fittings has hydraulically or pneumatically operated or threaded flanges that extend in order to interconnect pipes and provide flow of any type of material, such as fluid, gas, solid, or any combination thereof, in any type of piping system, e.g., shipping applications, marine applications, building applications, vehicle applications, aviation applications, etc. The coupler with expanding fittings can be used with piping systems using pipe made of any type of material, such as cast and wrought iron, steel, stainless steel, copper, brass, lead, non-ferrous and ferrous alloys, plastic materials, combinations thereof, etc.

The layout of most piping systems is not designed to precise tolerances. After a piping system has been constructed, it often takes pipe fitters or mechanics considerable time, effort and cost to place valves in the system. Frequently pipes must be cut, flanges welded in place, or inserts added to interconnect pipes and/or install a valve.

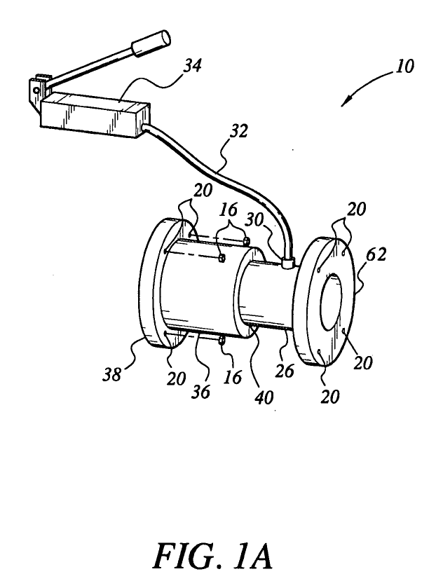

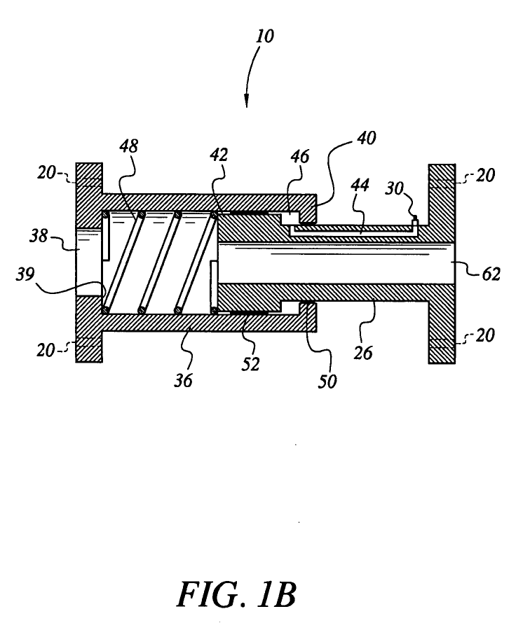

Referring to the drawings, FIGS. 1A and 1B show a coupler with expanding fittings, a first embodiment of which is designated generally as 10 in the drawings, that allows a pipe fitter to easily interconnect a pipe with another piping element, such as a valve, pipe angle, T-fitting, etc. The end to end distance of the coupler 10 can be easily adjusted so that the coupler 10 may be installed quickly and efficiently between a pipe and another piping element. The coupler 10 can be interconnected between pipe mains and pipe elements in systems designed for the delivery of a liquid, a gas, a solid, or combinations thereof. The coupler 10 includes an inner sleeve 26 and an outer sleeve 36. The inner sleeve 26 has a predetermined length and the relative position of the outer sleeve 36 is controlled by hydraulic or pneumatic pressure. Hydraulic or pneumatic pressure is applied through a hydraulic or pneumatic fitting 30 in the inner sleeve 26. Hydraulic fluid or a compressible gas can be added to the hydraulic or pneumatic fitting 30 on the inner sleeve 26 through a hydraulic or pneumatic line 32 attached to a hydraulic or pneumatic hand pump 34. Hydraulic or pneumatic line 32 may also be attached to a compressed gas source instead of hand pump 34.

The flanges 38 and 62 can be bolted to a flange of another pipe or pipe element (not shown) using nuts 16 and bolts inserted through the aligned holes 20 in the flanges 38 and 62 and holes in the other flange. The pipe fitter or mechanic can then use the hydraulic or pneumatic hand pump 34 to adjust the outer sleeve 36 over the inner sleeve 26 so that the flange 38 meets the flange of the other pipe element. A user may reverse the order of installing the coupler 10 to suit the particular piping system.

The internal configuration of the coupler 10 with expanding fitting is shown in FIG. 1B. The inner sleeve 26 has a hydraulic or pneumatic fitting 30 that leads to a hydraulic fluid or compressible gas passage 44 within the wall of the inner sleeve 26. The hydraulic fluid or pneumatic passage 44 leads to a void space 46 or cavity having an annular or cylindrical cross section. The void space 46 is a space formed by the exterior of the inner sleeve 26, the interior of the outer sleeve 36, the inward wall of the sleeve lip 40, and the inward wall of the sleeve lip 42. Additional components of the coupler 10 include a coil spring 48, an outer sleeve lip seal 50 and an inner sleeve lip seal 52. The coil spring 48 is placed between the outward wall of the sleeve lip 42 and an inwardly extending portion 39 of the flange 38. The outer sleeve lip seal 50 is attached to the inner face of the outer sleeve lip 40. The inner sleeve lip seal 52 encircles the sleeve lip 42.

FIG. 1B shows the outer sleeve 36 extended. When no hydraulic fluid or compressible gas is added to the void space 46, the coil spring 48 expands to push the outer sleeve 36 and flange 38 outward. In the event of failure of the hydraulic or pneumatic fitting 30 or either the outer sleeve lip seal 50 or the inner sleeve lip seal 52, so that hydraulic or pneumatic pressure is lost, the coupler 10 is in the extended position as a safety feature.

The coupler 10 with expanding fittings may come in a variety of sizes. For exemplary purposes only, the flanges 38 may be dimensioned and configured to be attached to pipe flanges associated with two, four, six, eight, ten inch pipe as well as metric and non-standard pipe sizes. As previously described, the coupler 10 with expanding fittings may be used to interconnect pipes and provide flow of any type of material, such as fluid, gas, solid, or any combination thereof, in any type of piping system, e.g., shipping applications, marine applications, building applications, vehicle applications, aviation applications, etc.

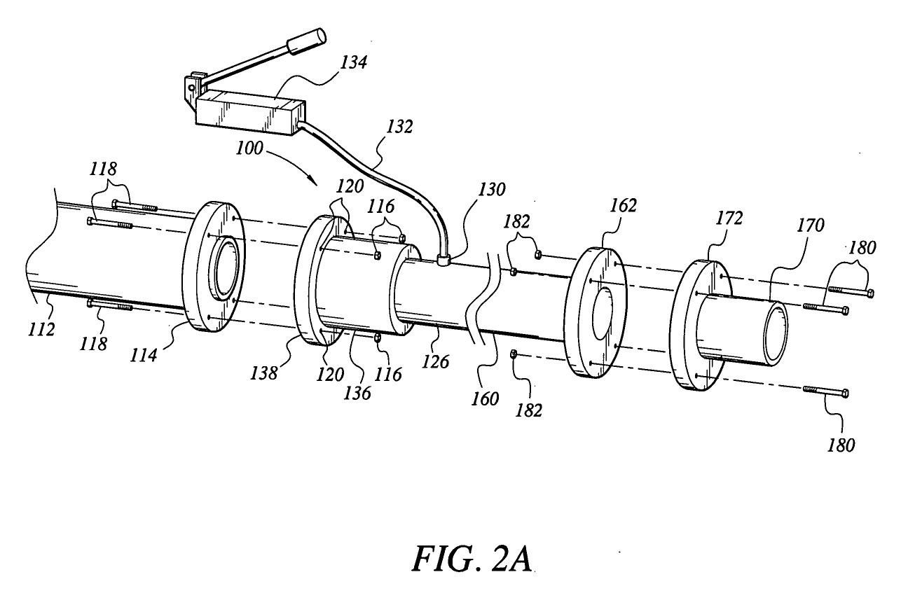

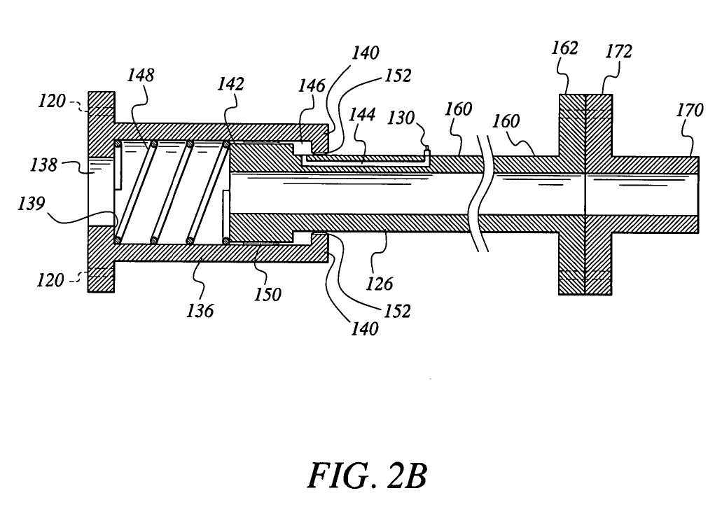

FIGS. 2A and 2B show a coupler 100 with expanding fittings that allows a pipe fitter to easily interconnect a pipe 112 with another pipe 160 equipped with the coupler 100 at one end. The end to end distance of the coupler 100 can be easily adjusted so that the coupler 100 may be installed quickly and efficiently between the pipe 112 and the pipe 160. The pipes 112 and 160 can provide for the flow of a liquid, a gas, a solid, or combinations thereof. The coupler 100 has an inner sleeve end 126 of pipe 160 and an outer sleeve 136. The inner sleeve end 126 of pipe 160 has a predetermined length and the relative position of the outer sleeve 136 is controlled by hydraulic or pneumatic pressure. Hydraulic or pneumatic pressure is applied through a hydraulic or pneumatic fitting 130 in the inner sleeve end 126 of pipe 160. Hydraulic fluid or compressible gas can be added to the hydraulic or pneumatic fitting 130 on the inner sleeve end 126 of pipe 160 through a hydraulic or pneumatic line 132 attached to a hydraulic or pneumatic hand pump 134. Hydraulic or pneumatic line 132 may also be attached to a compressed gas source instead of hand pump 134.

The flange 138 can be bolted to a flange 114 of pipe element 112 using nuts 116 and bolts 118 inserted through the aligned holes 120 in the flange 138 and corresponding holes in the flange 114. The pipe fitter or mechanic can then use the hydraulic hand pump 134 or a compressible gas source to adjust the outer sleeve 136 over the inner sleeve and 126 of pipe 160 so that the flange 138 meets the flange 114 of the pipe element 112. Pipe 160 may have a fixed flange 162 at a distal end opposite coupler 100. The flange 162 can be bolted to a flange 172 of another pipe 170 using nuts 182 and bolts 180 inserted through the aligned holes in the flange 162 and holes in the flange 172. The pipe fitter or mechanic can then use the hydraulic end pump 134 or a compressible gas source to adjust the outer sleeve 136 over the inner sleeve end 126 of pipe 160 so that the flange 138 meets the flange 114 of the pipe element 112. A user may reverse the order of interconnecting the pipes 112 and 160 to suit the particular piping system.

The internal configuration of the coupler 100 with expanding fitting is shown in FIG. 2B. The inner sleeve end 126 of pipe 160 has a hydraulic or pneumatic fitting 130 that leads to a hydraulic or pneumatic fluid passage 144 within the wall of the inner sleeve end 126 of pipe 160. The hydraulic or pneumatic fluid passage 144 leads to a void space 146 or cavity having a cylindrical cross section. The void space 146 is a space formed by the exterior of the inner sleeve end 126 of pipe 160, the interior of the outer sleeve 136, the inward wall of the outer sleeve lip 140, and the inward wall of the inner sleeve lip 142. Additional components of the coupler 100 include a coil spring 148, an inner sleeve lip seal 150 and an outer sleeve lip seal 152. The coil spring 148 is placed between the outward wall of the inner sleeve lip 142 and an inwardly extending portion 139 of the flange 138. The outer sleeve lip seal 152 is attached to the inner face of the outer sleeve lip 140. The inner sleeve lip seal 150 encircles the inner sleeve lip 142.

FIG. 2B shows the outer sleeve 136 fully extended. When no hydraulic fluid or compressible gas is added to the void space 146, the coil spring 148 fully expands to push the outer sleeve 136 and flange 138 outward. In the event of failure of the hydraulic or pneumatic fitting 130 or either the inner sleeve lip seal 150 or the outer sleeve lip seal 152, so that hydraulic or pneumatic pressure is lost, the coupler 100 is in the fully extended position as a safety feature.

The coupler 100 with expanding fittings may come in a variety of sizes. For exemplary purposes only, the flange 138 may be dimensioned and configured to be attached to pipe flanges associated with two, four, six, eight, ten inch pipe as well as metric and non-standard pipe sizes. As previously described, the coupler 100 with expanding fittings may be used to interconnect pipes and provide flow of any type of material, such as a liquid, a gas, a solid, or any combination thereof, in any type of piping system, e.g., shipping applications, marine applications, building applications, vehicle applications, aviation applications, etc.

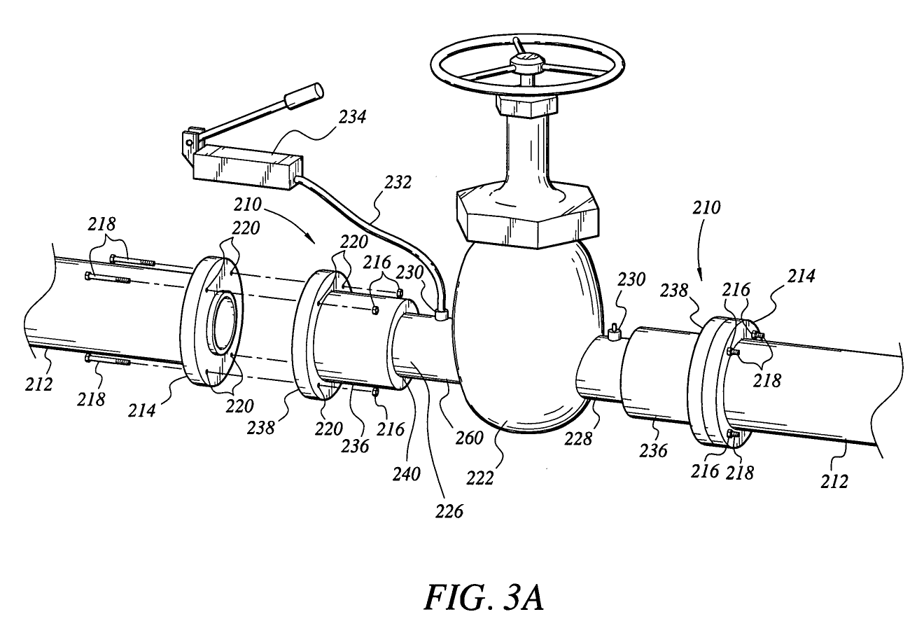

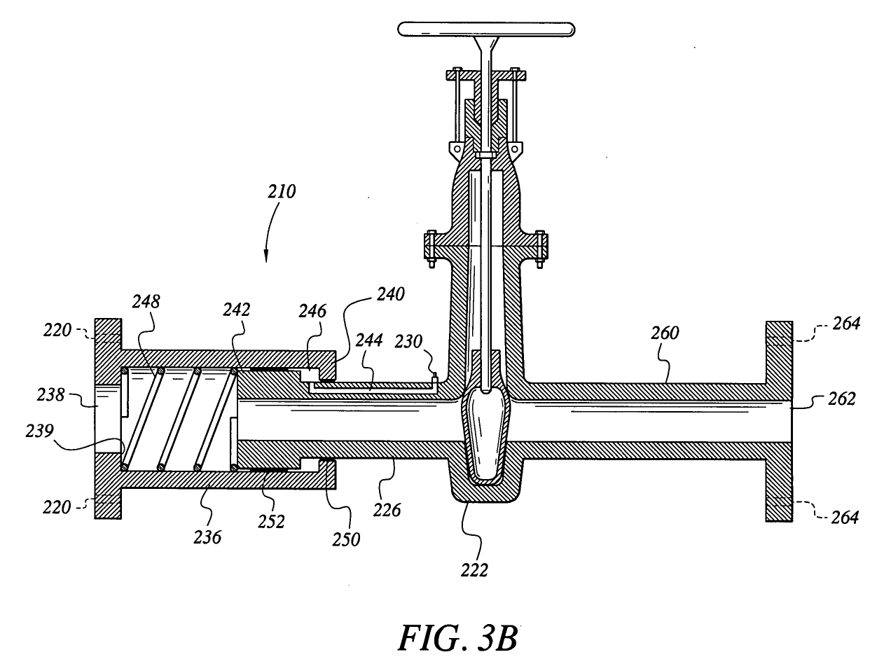

FIGS. 3A and 3B show a coupler 210 with expanding fittings that allows a pipe fitter to easily interconnect a pipe 212 and a globe valve 222 interconnected to a coupler 210 with a fixed flange 238, and another pipe 212. The end-to-end distance of the coupler 210 can be easily adjusted so that the coupler 210 may be installed quickly and efficiently between the pipe 212 and the globe valve 222. The globe valve 222 is conventional. The outlet pipe 228 on the globe valve 222 has a conventional fixed flange. The pipes 212 can provide flow of liquid, gas, solid, or combinations. The coupler 210 includes an inner sleeve 226 and an outer sleeve 236. The inner sleeve 226 has a predetermined length and the relative position of the sleeve 236 is controlled by hydraulic or pneumatic pressure. Hydraulic or pneumatic pressure is applied through a hydraulic or pneumatic fitting 230 in the inner sleeve 226. Hydraulic fluid or compressed gas can be added to the hydraulic or pneumatic fitting 230 on the inner sleeve 226 through a hydraulic or pneumatic line 232 attached to a hydraulic hand pump 234 (as shown) or a compressed gas source.

The flange 238 can be bolted to the flange 214 of the left pipe element 212 using nuts 216 and bolts 218 inserted through the aligned holes 220 in the flange 238 and holes in the flange 214. The pipe fitter or mechanic can then use the hydraulic or pneumatic hand pump 234 or a compressible gas source to adjust the outer sleeve 236 over the inner sleeve 226 so that the flange 238 meets the flange 214 of the pipe element 212.

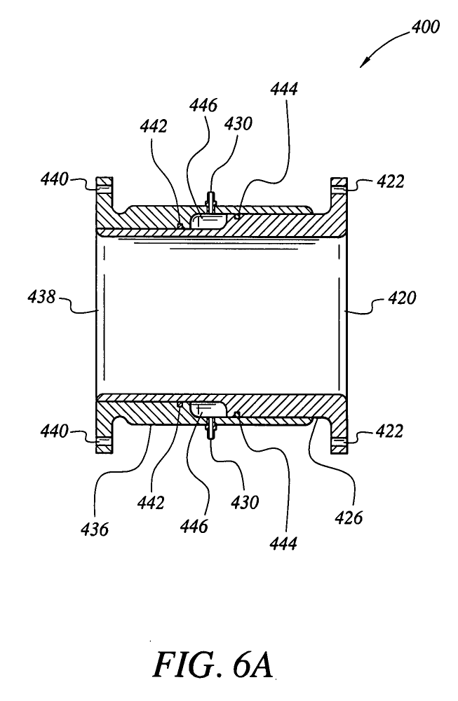

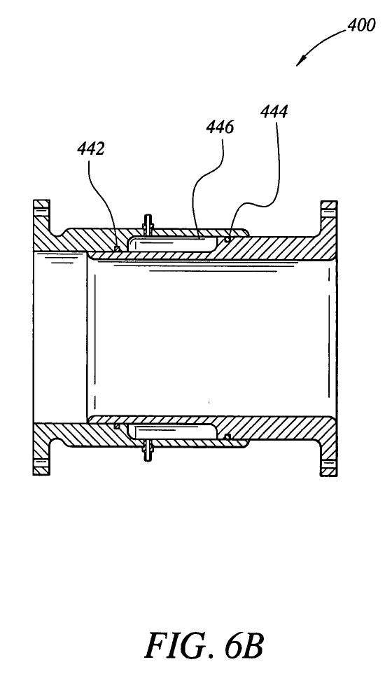

FIG. 3B shows the inner sleeve 226 attached to the globe valve 222, which has an outlet, pipe 260 (as shown in FIG. 6) with a fixed flange 262 at a distal end. The flange 262 can be bolted to a flange 214 of another pipe 212 using nuts 216 and bolts 218 inserted through the aligned holes in the flange 214 and holes 264 in the flange 262. The pipe fitter or mechanic can then use the hydraulic or pneumatic hand pump 234 or a compressible gas source to adjust the powder sleeve 236 over the inner sleeve 226 so that the flange 238 meets the flange 214 of the pipe element 212. A user may reverse the order of interconnecting the pipes 212, the globe valve 222, and the pipe 260 to suit the particular piping system. The inner sleeve 226 has a hydraulic or pneumatic fitting 230 that leads to a hydraulic or pneumatic fluid passage 244 within the wall of the inner sleeve 226. The hydraulic or pneumatic fluid passage 244 leads to a void space 246 having a cylindrical cross section. The void space 246 is a space formed by the exterior of the inner sleeve 226, the interior of the outer slave 236, the inward wall of the outer sleeve lip 240, and the inward wall of the inner sleeve lip 242. Additional components of the coupler 210 include a coil spring 248, an inner sleeve lip seal 250 and an outer sleeve lip seal 252. The coil spring 248 is placed between the outward wall of the inner sleeve lip 242 and the inward wall 239 of the flange 238. The inner sleeve lip seal 250 is attached to the inner face of the outer sleeve lip 240. The outer sleeve lip seal 252 encircles the inner sleeve lip 242.

FIG. 3B shows the outer sleeve 236 fully extended. When no hydraulic or pneumatic fluid is added to the void space 246, the coil spring 248 fully expands to push the outer sleeve 236 and flange 238 outward. In the event of failure of the hydraulic or pneumatic fitting 230 or either the inner sleeve lip seal 250 or the outer sleeve lip seal 252, so that hydraulic or pneumatic pressure is lost, the coupler 210 is in the fully extended position as a safety feature.

The coupler 210 with expanding fittings may come in a variety of sizes. For exemplary purposes only, the flange 238 may be dimensioned and configured to be attached to pipe flanges associated with two, four, six, eight, ten inch pipe as well as metric and non-standard pipe sizes. As previously described, the coupler 210 with expanding fittings may be used to interconnect pipes and provide flow of any type of material, such as fluid, gas, solid, or any combination thereof, in any type of piping system, e.g., shipping applications, marine applications, building applications, vehicle applications, aviation applications, etc.

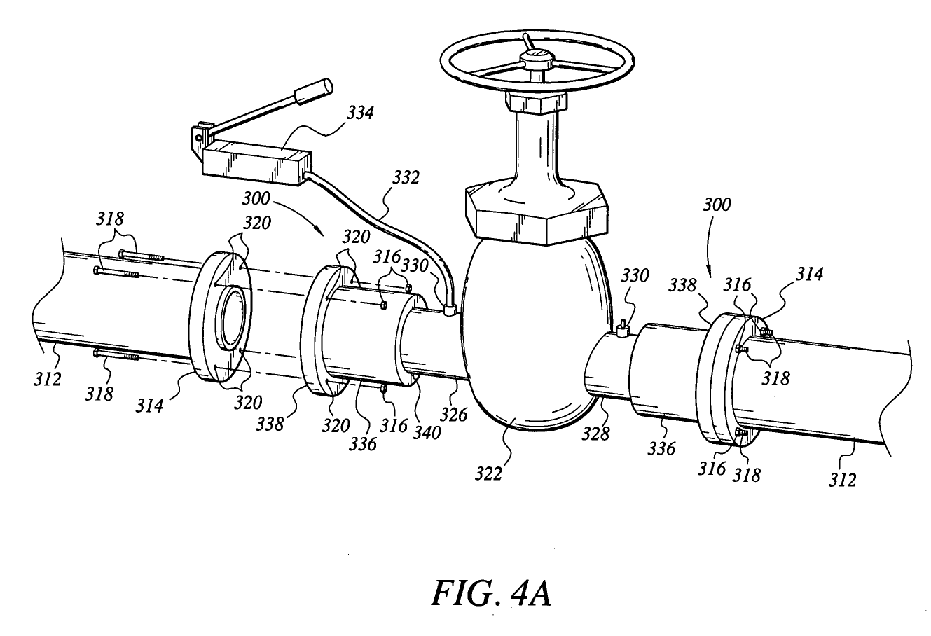

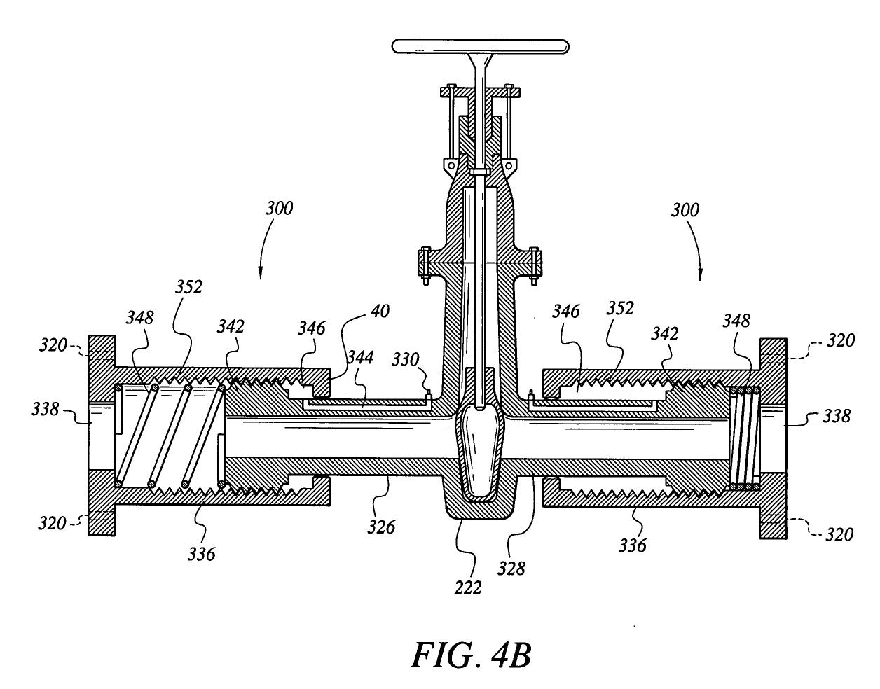

FIGS. 4A and 4B show another example of a coupler 300 with expanding fittings that allows a pipe fitter to adjust the distance between flanges on a valve so that a valve may be installed quickly and efficiently. A globe valve 322 is interconnected to either end of a coupler 300 with expanding fittings. Each coupler 300 is interconnected to a liquid, gas, solid, or combinations thereof, pipe main 312 or other pipe run. The globe valve 322 is conventional, except that the inlet pipe 326 and the outlet pipe 328 on the globe valve 322 do not have conventional fixed flanges. The valve body can be a globe valve, a gate valve, or other type of valve. Both the inlet pipe 326 and the outlet pipe 328 are connected to the globe valve 322 by valve flanges 338 connected to an outer sleeve 336 that slides on the exterior of the respective pipes. The relative position of the outer sleeves 336 to inlet pipe 326 an outlet pipe 328 is controlled by threading.

The valve flange 338 is bolted to the flange 314 on the liquid, gas, solid, or combinations thereof main 312 using nuts 316 and bolts 318 inserted through the aligned holes 320 in the liquid, gas, solid, or combinations thereof main flange 314 and the valve flange 338. The pipe fitter or mechanic then uses the hydraulic or pneumatic hand pump 334 or a compressible gas source to adjust the outer sleeve 336 over the inlet pipe 326 so that the valve flange 338 meets the opposite liquid, gas, solid, or combinations thereof main flange 314. A user may reverse the order of installing the coupler 300 with expanding fittings to suit the particular piping system. It is also contemplated that the coupler 300 with expanding fittings may be equipped with expanding fittings either only on the inlet pipe 326 or only on the outlet pipe 328, in which case the other pipe can have a conventional fixed flange fitting.

The internal configuration of the valve with expanding fitting 300 is shown in FIG. 4B. Both the inlet pipe 326 and the outlet pipe 328 feature threads 342 that engage with inner threads 352 on the inside of outer sleeve 336. A void space 346 is a space formed by the exterior of the inlet pipe 326 (or outlet pipe 328), the threaded interior of the outer sleeve 336, the inward wall of the inlet pipe 326 or outlet pipe 328 sleeve lip, and threads 342. Additional components of the coupler 300 can include a coil spring 348. The coil spring 348 is placed between the outward wall of inlet pipe 326 or outlet pipe 328 and the inward wall of the valve flange 338. The outer sleeve threads 352 engage with the threads 342 on the outward end of inlet pipe 326 or outlet pipe 328.

The inlet pipe 326 shows an outer sleeve 336 that is fully extended. When the inlet pipe 326 has been rotated to fully extend the outer sleeve 336, the optional coil spring 348 biases to lock the outer sleeve 336 in a fixed position. The outlet pipe 328 has an outer sleeve 336 that is fully compressed. When a user of the coupler 300 adjusts the outlet pipe 328 to fully compress the sleeve, the optional coil spring 348 biases the lock the outer sleeve 336 in a fixed position. The threads can be formed of carbon, self lubricating plastic, self lubricating rubber, or other suitable sealing material.

The coupler 300 with expanding fittings may come in a variety of sizes. For exemplary purposes only, the valve flanges 338 may be dimensioned and configured to be attached to the pipe flanges associated with two, four, six, eight, and ten inch pipe as well as metric and non-standard pipe sizes. As previously described, the expanding fittings may be used in combination with any type of valve known in the art, and for any type of piping system, e.g., shipping applications, marine applications, building applications, vehicle applications, aviation applications, etc.

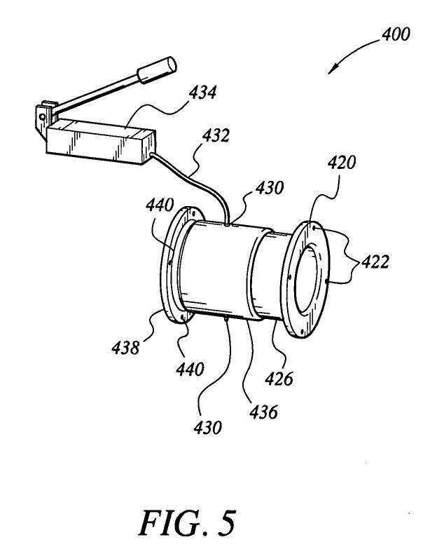

FIGS. 5 through 6B show an alternative embodiment of the coupler 400 similar to the embodiment as shown in FIGS. 1A and 1B. The two major differences of this alternative embodiment are that there is no biasing coil spring 48 as shown in FIGS. 1A and 1B, and the hydraulic or pneumatic fluid passage 44 of FIGS. 1A and 1B has been redesigned to a short axial passage rather than a passage formed in a longitudinal direction through the inner sleeve.

FIG. 5 shows the coupler 400 having an inner sleeve 426 connected to an inner sleeve flange 420 having through holes 422 for connecting to other pipe hardware. An outer sleeve 436 is slidingly affixed over inner sleeve flange 426 on a first end and is connected to an outer sleeve flange 438 at an opposite end having through holes 440 for connecting to other pipe hardware. Hydraulic or pneumatic hand pump 434 is connected to the coupler 400 via a hydraulic or pneumatic line 432 that attaches to a hydraulic or pneumatic fitting 430 on the outer sleeve 436.

FIGS. 6A and 6B show a sectional view of the alternative embodiment in a collapsed or pre-expanded configuration in FIG. 6A, and an expanded configuration and FIG. 6B. In these figures, an outer sleeve gasket 442 and an inner sleeve gasket 444 are disposed between the outer sleeve 436 and the inner sleeve 426 to prevent hydraulic or pneumatic fluid from escaping from a hydraulic or pneumatic fluid chamber 446. When the coupler 400 is desired to be expanded, hydraulic or pneumatic fluid is forced through the hydraulic or pneumatic fitting 430 into the hydraulic fluid chamber 446 causing the hydraulic or pneumatic fluid chamber 446 to force the inner sleeve 426 away from the outer sleeve 436, thereby extending the coupler 400.

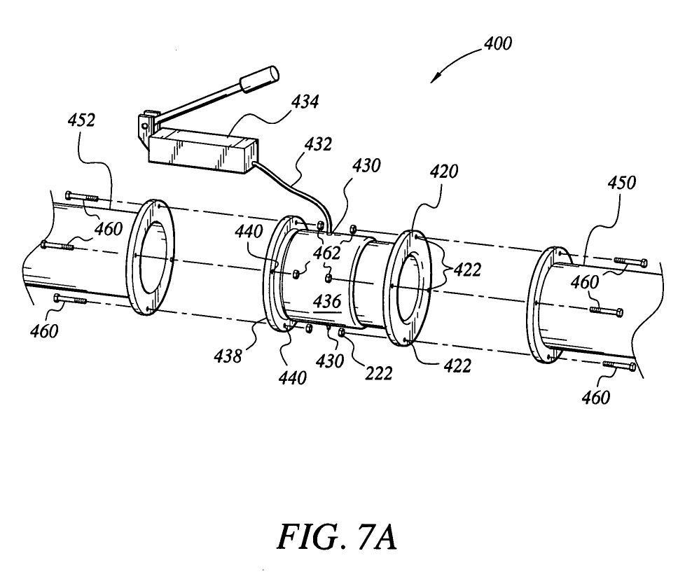

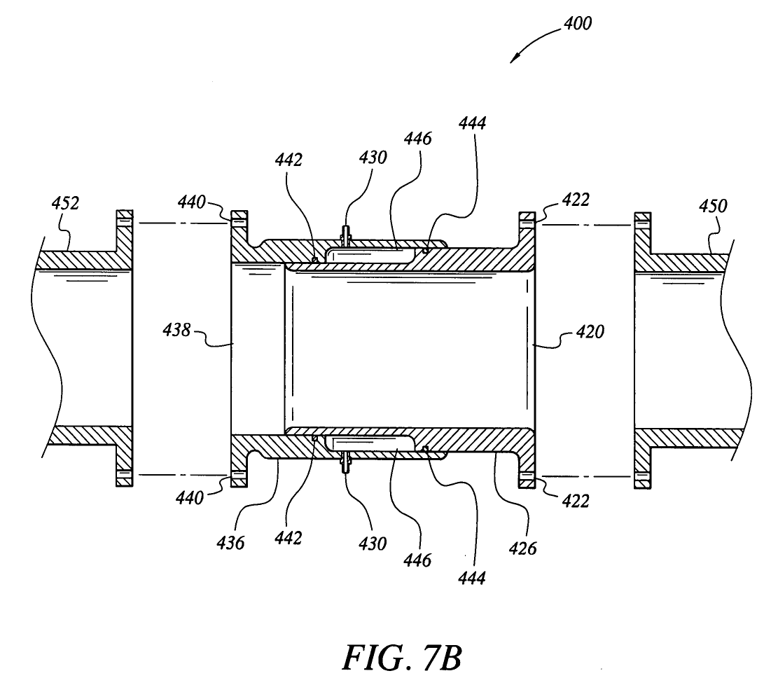

FIGS. 7A and 7B demonstrate how coupler 400 may be interposed between a first pipe 450 and a second pipe 452. The through holes in each end of the flanges 420 and 438 of coupler 400 mate reciprocally with corresponding through holes 440 and 442 when the coupler 400 is expanded. Conventional fastening hardware bolts 460 and nuts 462 may then be used to fasten the coupler 400 between pipes 450 and 452.

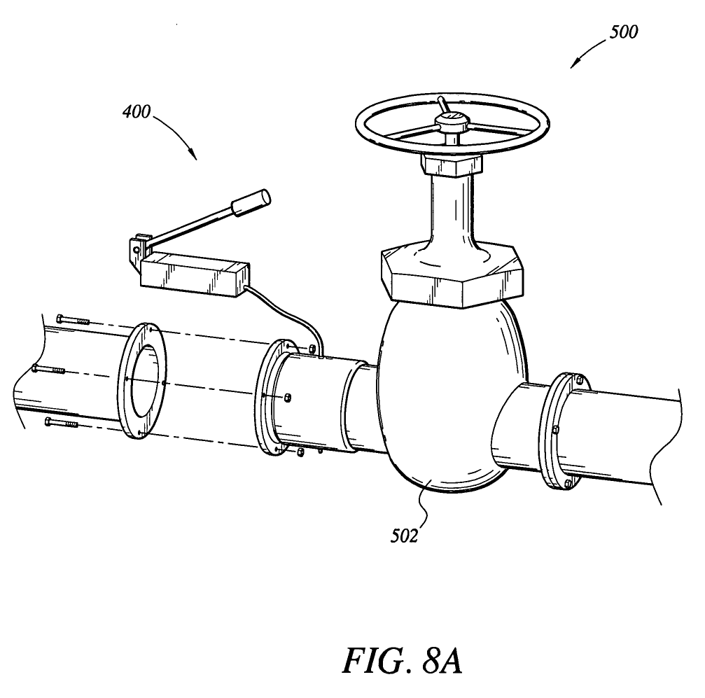

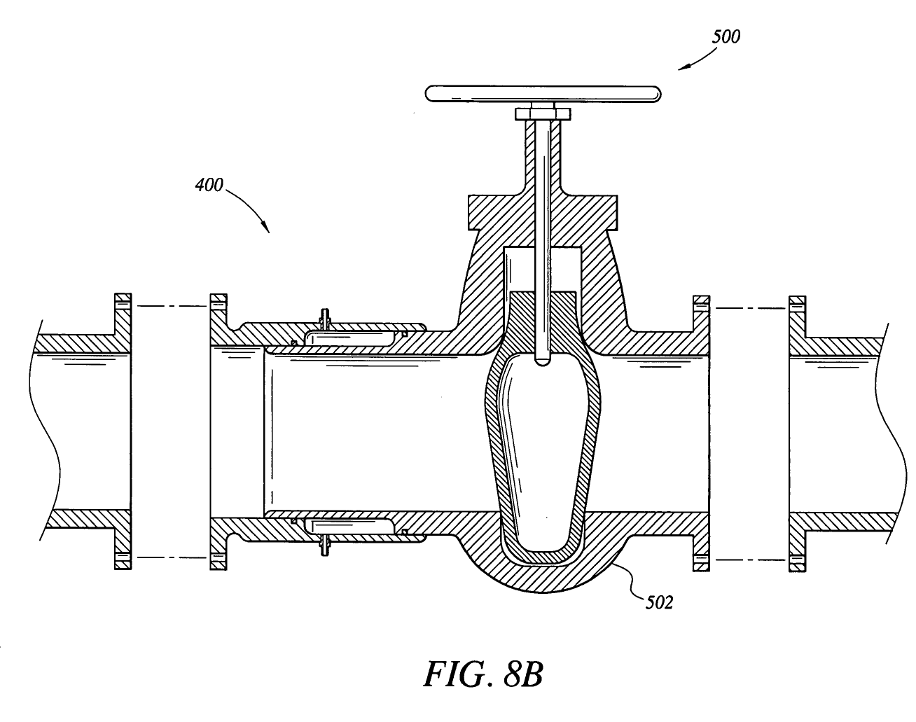

FIGS. 8A and 8B show the coupler 400 of FIGS. 5 through 7B connected to a globe valve 500 in similar manner to FIGS. 3A and 3B. In this embodiment, the inner sleeve 426 of FIGS. 5 through 7B is now integrally connected at a lower portion 502 of the globe valve 500.

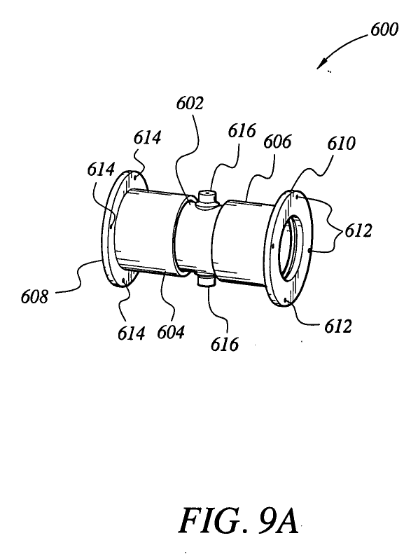

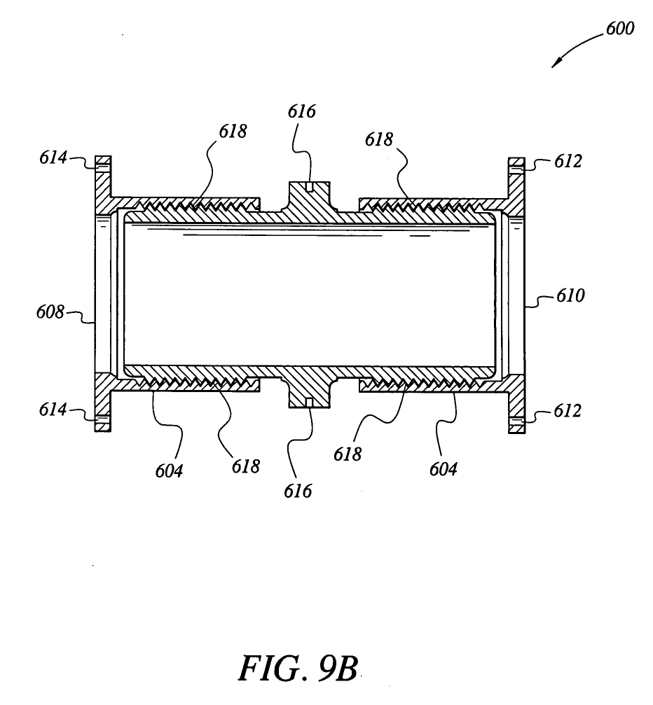

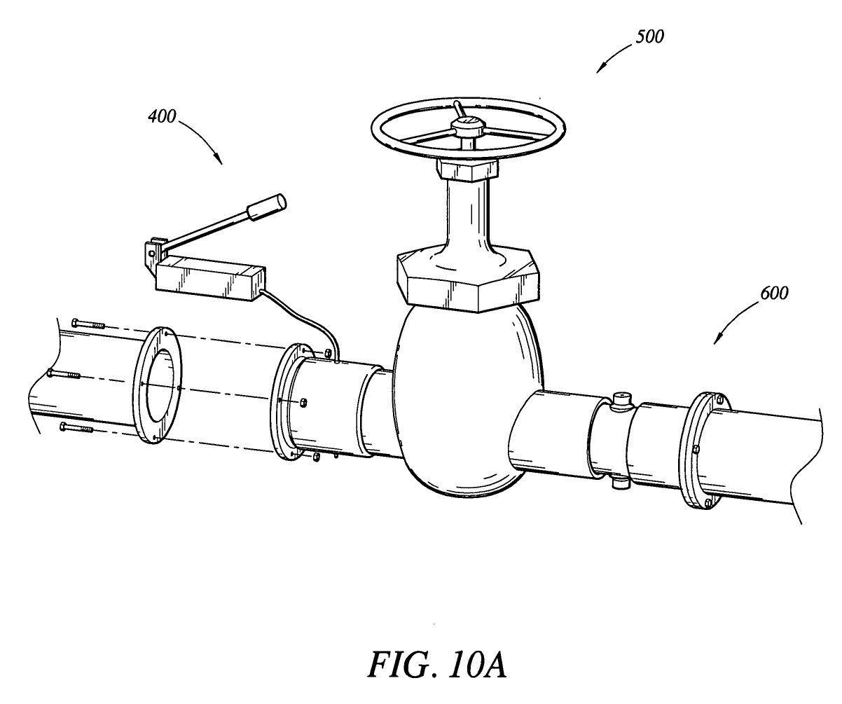

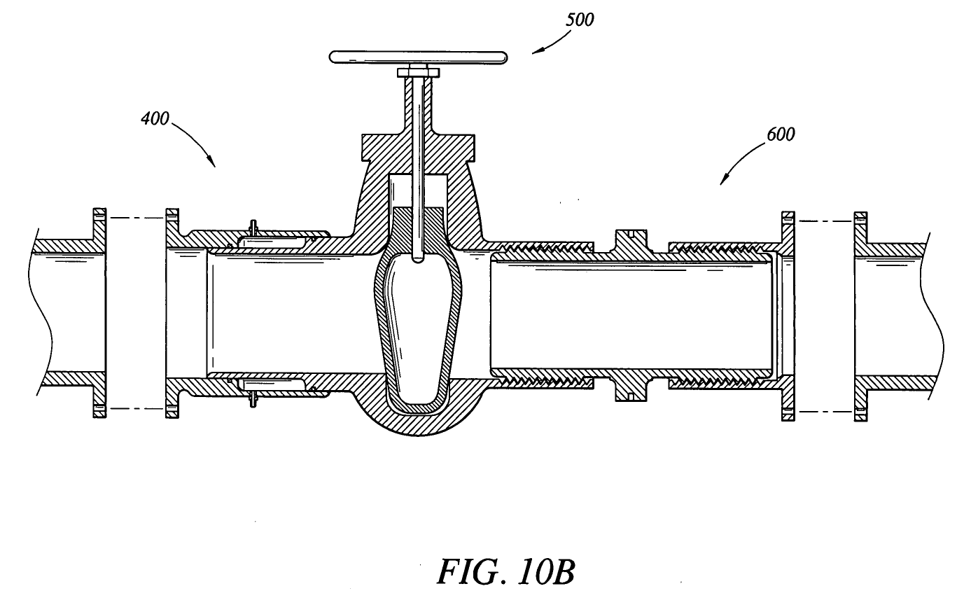

FIGS. 9A through 10B show an additional alternative embodiment of the present invention as illustrated by coupler 600. Coupler 600 differs from the embodiment shown in FIG. 4B in that it does not have a biasing spring 348 and a hydraulic or pneumatic actuating chamber 346. Coupler 600 has an inner rotatable sleeve 602 threaded on opposing ends that mate with a first outer sleeve 604 and a second outer sleeve 606. Each outer sleeve has an internally threaded portion designed to receive the threaded portion of the inner rotatable sleeve 602. The first and second outer sleeves 606 and 604 have integrally attached mounting flanges 608 and 610, respectively, through which fastening through holes 612 and 614 are designed to receive fastening hardware. The threaded portions 618 of the inner rotatable sleeve 602 and first and second outer sleeves 604 and 606 are designed to cause the first and second outer sleeves 604 and 606 to move away from each other when the inner rotatable sleeve 602 is turned in one direction, and to move toward each other when the inner rotatable sleeve 602 is turned in the opposite direction. A turning attachment point 616 is designed to receive any type of tool or attachment means necessary to rotate the inner rotatable sleeve 602 and a desire direction. For example, a pipe whose inner diameter is sufficient to fit over the turning attachment point 616 may be positioned as a lever to assist in turning the inner rotatable sleeve 602.

FIGS. 10A and 10B illustrate the hydraulically or pneumatically actuated coupler 400 of FIGS. 5 through 8B and the threaded rotatable sleeve coupler 600 of FIGS. 9A and 9B attached to a globe valve 500 in a manner similar to FIGS. 3A through 4B.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A coupler with expanding fittings, comprising:
an inner sleeve having an annular wall with an outwardly extending lip about an end of the inner sleeve, the wall of the inner sleeve having a passage defined therein having an inlet disposed on an exterior of the sleeve and having a discharge opening adjacent the lip; and
an outer sleeve having a pipe flange at a first end and an inwardly extending lip at an opposing second end, the inwardly extending lip being slidably disposed upon the inner sleeve and encircling the inner sleeve, the discharge opening being disposed between the outwardly extending lip of the inner sleeve and the inwardly extending lip of the outer sleeve;
wherein the outer sleeve travels along the outward surface of the outward extending lip of the inner sleeve, the range of travel of the outer sleeve being limited by the inwardly extending lip of the inner sleeve.

2. The coupler with expanding fittings according to claim 1, further comprising a compression spring disposed between the outwardly extending lip of the inner sleeve and the pipe flange.

3. The coupler with expanding fittings according to claim 1, further comprising a hydraulic or pneumatic fitting attached to the passage inlet, the fitting being adapted for attachment to a hydraulic pump or a compressible gas source.

4. The coupler with expanding fittings according to claim 1, further comprising a seal disposed between the inwardly extending lip and the inner sleeve.

5. The coupler with expanding fittings according to claim 1, further comprising a seal disposed between the outwardly extending lip of the inner sleeve lip and the outer sleeve.

6. The coupler with expanding fittings according to claim 1, in combination with a pipe and a pipe element, the pipe having a flange interconnected to the flange of the outer sleeve.

7. The coupler with expanding fittings according to claim 6, wherein said pipe element comprises a second pipe having a fixed flange.

8. The coupler with expanding fittings according to claim 6, wherein said pipe element comprises a valve.

9. The coupler with expanding fittings according to claim 8, wherein said valve comprises a globe valve.

10. The coupler with expanding fittings according to claim 8, in combination with a second pipe, the second pipe being interconnected to the valve and having a fixed flange.

11. A coupler with expanding fittings, comprising:
an inner sleeve having an annular wall with an outwardly extending lip about an end of the inner sleeve, the outwardly extending lip having external threading formed thereon; and
an outer sleeve having an attached pipe flange at a first end, an inwardly extending lip at an opposing second end, and an internally threaded wall disposed between the first end and the second end, the internally threaded wall being in threaded engagement with the external threading of the inner sleeve;
whereby rotation of the outer sleeve results in changing distance between the ends of the coupler, the range of travel of the outer sleeve being limited by the inwardly extending lip on the outer sleeve.

12. The coupler with expanding fittings according to claim 11, further comprising a compression spring disposed between the outwardly extending lip of the inner sleeve and the pipe flange.

13. The coupler with expanding fittings according to claim 11, further comprising a compression spring disposed between the outwardly extending lip of the inner sleeve and the pipe flange.

14. The coupler with expanding fittings according to claim 11, in combination with a pipe and a pipe element, the pipe having a flange interconnected to the flange of the outer sleeve.

15. The coupler with expanding fittings according to claim 14, wherein said pipe element comprises a second pipe having a fixed flange.

16. The coupler with expanding fittings according to claim 14, wherein said pipe element comprises a valve.

17. The coupler with expanding fittings according to claim 16, wherein said valve comprises a globe valve.

18. The coupler with expanding fittings according to claim 16, in combination with a second pipe, the second pipe being interconnected to the valve and having a fixed flange.

19. A pipe coupler with expanding fittings, comprising:
an inner sleeve having an annular wall and an outwardly facing annular recess defined around an end of the inner sleeve; and
a outer sleeve having an annular wall and an inwardly facing annular recess around an end of the outer sleeve, the inwardly facing annular recess of the outer sleeve being slidably disposed over and encircling the inner sleeve, the wall of the outer sleeve at the inwardly facing annular recess having a passage defined therethrough, the passage having an inlet disposed on an exterior of the outer sleeve and having a discharge opening into an enclosed annular cavity defined by the outwardly facing annular recess of the inner sleeve and the inwardly facing annular recess of the outer sleeve;
whereby the outer sleeve travels along the outwardly facing annular recess of the inner sleeve and the outer surface of the inner sleeve, the range of travel of the outer sleeve being limited by the outwardly facing annular recess of the inner sleeve.

20. The pipe coupler with expanding fittings of claim 19, further comprising:
a first gasket positioned between the inwardly facing annular recess of the outer sleeve and the inner sleeve; and
a second gasket positioned between the outwardly facing annular recess of the inner sleeve and the outer sleeve.

21. A coupler with expanding fittings, comprising:
an inner sleeve having an annular wall and two ends, each of the ends having external threading formed thereon; and
a plurality of outer sleeves, each of the outer sleeves having an attached pipe flange at a first end and an internally threaded wall disposed between the first end and the second end, the internally threaded walls of each of the outer sleeves being in threaded engagement with the external threading formed on the inner sleeve;
whereby rotation of the inner pipe results in changing distance between the ends of the coupler, a range of travel of the inner sleeve being limited by the external threading formed on the two ends of the inner sleeve.

22. The coupler with expanding fittings of claim 21, further comprising a turning attachment point mounted centrally on the external surface of the inner sleeve and positioned between the set of outer sleeves, wherein the turning attachment point provides additional mechanical leverage for turning the inner sleeve with respect to the set of outer sleeves by attaching an elongated lever thereto.
